(19) United States
(12) Patent Application Publication
(10) Pub. No.: US 2009/0104993 A1
(43) Pub. Date: Apr. 23, 2009

(54) Electronic game controller with motion-sensing capability

(76) Inventor: Zhou Ye, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,685

(22) Filed: Jun. 9, 2008

(30) Foreign Application Priority Data
Oct. 17, 2007 (TW) 96138864

(51) Int. Cl. A63F 13/00

(52) U.S. Cl. 463/39

(57) ABSTRACT

An electronic game controller with motion-sensing capability includes an inertia sensing and wireless transmission unit, an image sensing unit and a control unit. The image sensing unit extracts and recognizes the images of the profile of the user's body to generate signals indicative of the displacement or specific postures of the user. The inertia sensing and wireless transmission unit senses the motions of the user's body to generate signals indicative of the rotation, rhythmic motions, swing or force of the user's body. The control unit receives the signals and integrates them to generate control signals, thereby controlling the marker on the display picture of the electronic game. With the cooperation of the image sensing unit and the inertia sensing and wireless transmission unit, various motions or exercising states of the user can be sensed, thereby providing the user with a more complete and exquisite operating interface for the electronic game.

### BACKGROUND OF THE INVENTION

1. Field of the Invention

The present invention relates to an electronic game controller with motion-sensing capability, and in particular to an electronic game controller with motion-sensing capability, whereby the user can control a marker on a display picture to play an electronic game.

2. Description of Related Art

The rapid development of electronic elements and software has lead to a larger choice of operating interfaces for the electronic games. Thus, the operating interfaces of electronic games are not restricted to the traditional control plate or operating handle. In order to increase the fun in playing electronic games, there is an increasing demand for a more complete user operating interface.

The conventional inertia sensing element utilizes the sensed motions of the user to control a marker on the display picture. For example, the user puts the inertia sensing element on his/her body or holds the inertia sensing element, whereby the inclination, swing or rhythmic motion of the user can be sensed by the inertia sensing element so as to generate signals. However, the general displacement, posture and gesture of the user cannot be recognized and detected by the conventional inertia-sensing element easily. Thus, the user needs to operate another control device (such as another operating handle) to input and operate the signals indicative of the displacement of the user.

The conventional way of operating the marker on the display picture by extracting the change of body profile is to use an image extracting unit (such as a video camera) to receive the image of the user's body. Further, by using other electronic elements or arithmetic process of software, the change of images in a simulated planar coordinate can be recognized. For example, the vertical or horizontal displacement of the image in the simulated planar coordinate can make the marker to move vertically or horizontally on the display picture. Magnifying or reducing the image can make the marker move forward or backward on the display picture. However, if more motions of the user's body are to be sensed (such as rotation, rhythmic motion, swing or force), it is necessary to provide more video cameras to extract the change in the profile of. the user's body. Further, a large number of images need to be digitized and processed. As a result, the response of the marker will become slow and inaccurate. On the other hand, higher data processing speed of the electronic apparatuses used for extracting and processing images is likely to increase the cost of the device.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide an electronic game controller with motion-sensing capability. By combining at least two ways of sensing the motions of user's body, a more complete control interface for the electronic game is provided, so that the user can control a marker on a display picture of an electronic game.

In order to achieve the above objects, the present invention provides an electronic game controller with motion-sensing capability for sensing the profile and motions of a user to generate signals, thereby controlling the marker of the display picture of the electronic game. The electronic game controller includes: an inertia sensing and wireless transmission unit comprising an inertia sensing module, an inertia signal calculating module and a wireless transmission module, the inertia sensing module sensing acceleration and angular speed of the motion of the user to generate signals, the inertia signal calculating module receiving the signals from the inertia sensing module to generate new signals indicative of the acceleration and angular speed of the motion of the user, the wireless transmission module receiving the signals from the inertia signal calculating module and outputting the signals by means of wireless transmission; an image sensing unit comprising an image extracting module and an image signal calculating module, the image extracting module receiving all or part of the images of the profile of the user's body, the image signal calculating module receiving the images extracted by the image extracting module and digitizing the images, thereby recognizing the change of the images in one time axis and outputting the signals indicative of the displacement of the user's body; and a control unit receiving and integrating the signals from the wireless transmission module and the image signal calculating module to generate control signals, thereby controlling the marker on the display picture of the electronic game.

The present invention has advantageous effects as follows. The inertia sensing and wireless transmission unit senses the acceleration and angular speed of the user's body, thereby generating signals indicative of the movements and exercising states of the user's body such as rotation, rhythmic motions, swing or force. Thus, the present invention has high sensitivity and conforms to the requirement for prompt control. The image sensing unit extracts the images of the profile of the user's body, and then these images are processed and calculated to generate signals indicative of the displacement or special posture of the user's body. In this way, with looking at the display picture of the electronic game, the user can observe his/her movements, and make response promptly according to the contents of the game, thereby increasing the correlation with the contents of the game in playing the interactive electronic game. With the control unit integrating the signals from the inertia sensing and wireless transmission unit and the image sensing unit, the present invention can have good sensitivity and conform to the requirement for prompt control. Also, the procedure or device for processing the images can be simplified. On the other hand, with the cooperation between the inertia sensing and wireless transmission unit and the image sensing unit, the present invention can act as a more complete and exquisite control interface for an electronic game, thereby increasing the fun in playing the interactive and simulated electronic game.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is a block view showing the electronic game controller with motion-sensing capability of the present invention;

FIG. 2 is a schematic view showing the electronic game controller with motion-sensing capability of another embodiment of the present invention;

FIG. 3 is a block view showing the electronic game controller with motion-sensing capability of a further embodiment of the present invention;

### DETAILED DESCRIPTION OF THE PREFERRED EMBODIMENTS

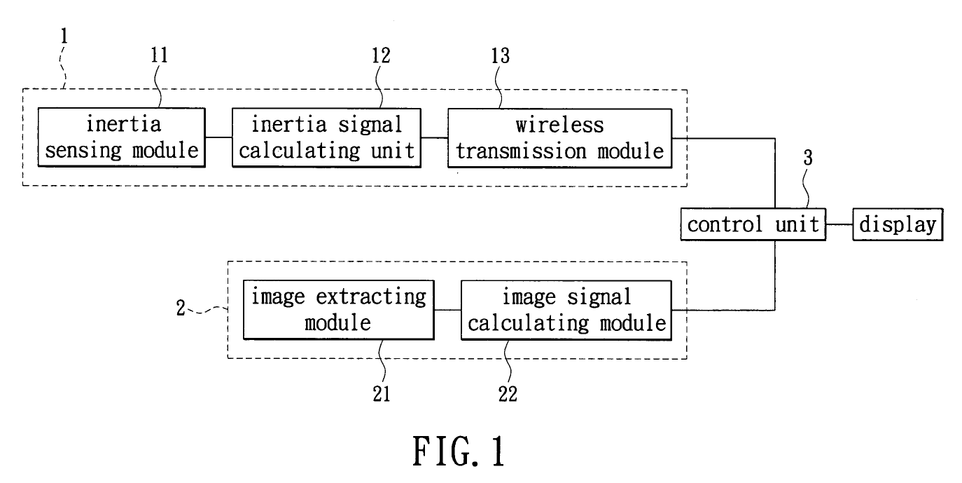

Please refer to FIG. 1, which shows an electronic game controller with motion-sensing capability in accordance with an embodiment of the present invention. The controller of the present invention is used to sense the motions and profile of the user's body and generate signals, thereby controlling a marker on the display picture of the electronic game, which includes an inertia sensing and wireless transmission unit 1, an image sensing unit 2 and a control unit 3. The inertia sensing and wireless transmission unit 1 comprises an inertia sensing module 11, an inertia signal calculating module 12 and a wireless transmission module 13. The inertia sensing module 11 is used to detect the components of acceleration and angular speed of the user's body along X axis, Y axis and Z axis and generate signals. In the present embodiment, the inertia sensing module 11 is arranged near the center of gravity of the user's body (such as the waist) or is held in one hand of the user. The inertia sensing module 11 comprises at least one accelerometer or at least one gyroscope. The inertia signal calculating module 12 is used to receive the signals from the inertia sensing module 11, and the received signals are calculated and processed to generate new signals indicative of the acceleration and angular speed of the center of gravity or limbs of the user. The wireless transmission module 40 is used to receive the signals generated by the inertia signal calculating module 12 and transmit the signals to the control unit 3 by means of wireless transmission.

The image sensing unit 2 comprises an image extracting module 21 and an image signal calculating module 22. The image extracting module 21 can be one or plural video cameras arranged to aim at the user. For example, the image extracting module 21 can be arranged in the front, upside, left and right or the back of the user who faces the display picture of the electronic game. Alternatively, a head mounted display can be cooperatively arranged at one or several locations around the user. In this way, the image extracting module 21 aims at the user so as to extract all or part (such as face) of the images of the profile of user's body. The images of the user's body extracted by the image extracting module 21 are transmitted to the image signal calculating module 22 to be digitized and defined in a planar reference coordinate. The image signal calculating module 22 calculates and processes the images of the user defined in the planar reference coordinate, thereby recognizing the change of images in the planar reference coordinate with respect to a time axis. When the user's body moves leftwards, rightwards, upwards, downwards, forwards, backwards, or makes some postures and gestures, the images defined in the planar reference coordinate will generate leftward, rightward, upward or downward displacement, magnified or minified area or changes in shape correspondingly. According to the changes in the planar coordinate, the image signal calculating module 22 further generates signals indicative of the leftward, rightward, upward, downward, forward backward displacement or the special posture and gesture of the user.

The control unit 3 receives the signals from the inertia signal calculating module 12 (via the wireless transmission module 13) and the image signal calculating module 22, and integrates these two sets of signals with respect to a time axis so as to generate control signals in response to various motions of the user. For example, the control unit 3 can process the signals from the inertia signal calculating module 12 to generate control signals indicative of the rotation, rhythmic motions (running), swing or force. Alternatively, the signals from the image signal calculating module 22 can be combined to generate control signals indicative of the displacement or posture change of the user.

When the user utilizes the present invention and a game host or a computer to play an interactive electronic game, the inertia sensing and wireless transmission unit 1 and the image sensing unit 2 senses the signals of the motions of the user and generates control signals via the control unit 3, thereby controlling the marker on the display picture of the electronic game. In this way, the marker can simulate various motions of the user's body.

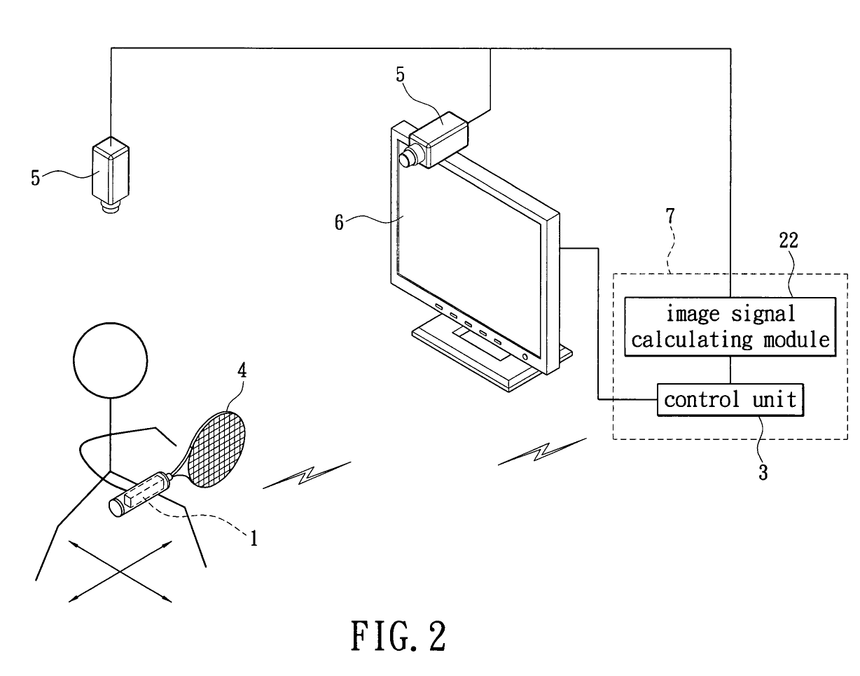

Please refer to FIG. 2, which shows another embodiment of the present invention. In this embodiment, the user utilizes the present invention to play an interactive electronic game of simulated tennis. The user holds an operating device 4 containing the inertia sensing and wireless transmission unit 1. The image extracting module 21 is two video cameras 5. The two video cameras 5 are provided on the front and upside of the user who faces the display picture of the electronic game, that is, one is located above a display 6 and the other is located above the head of the user. Both video cameras aim at the user. In this way, the inertia sensing and wireless transmission unit 1 mounted in the operating device 4 can sense the motions of the user's hands such as the swing and rotation via the inertia sensing module 11 to generate signals. The inertia signal calculating module 12 receives the signals from the inertia sensing module 11 and processes these received signals to generate new signals indicative of the motions of the user's hands such as swing or rotation. The wireless transmission module 13 receives the signals generated by the inertia signal calculating module 12 and then transmits the signals to the control unit 3 of a computer 7. On the other hand, the video camera 5 located in the front of the user (that is, above the display) can extract the images of the profile of the user's body, and transmit the images to the image signal calculating module 22 of the computer 7. After the calculating process of the image signal calculating module 22, the images are recognized to generate signals indicative of the leftward and rightward displacements of the user with respect to the display picture. Similarly, the video camera 5 located above the head of the user extracts the images of the profile of the user's body and transmits the images to the image signal calculating module 22. After being calculated and processed, the images are recognized to generate signals indicative of the forward or backward displacements of the user with respect to the display picture. The signals generated by the inertia signal calculating module 12 (via the wireless transmission module 13) and the image signal calculating module 22 are transmitted to the control unit 3. The control unit 3 integrates the signals with respect to a time axis, thereby generating control signals corresponding to various motions of the user and controlling the marker indicative of the user on the display picture. In this way, a state of stimulating a user to play tennis can be generated, thereby providing a game as if the user is playing tennis in a real tennis court.

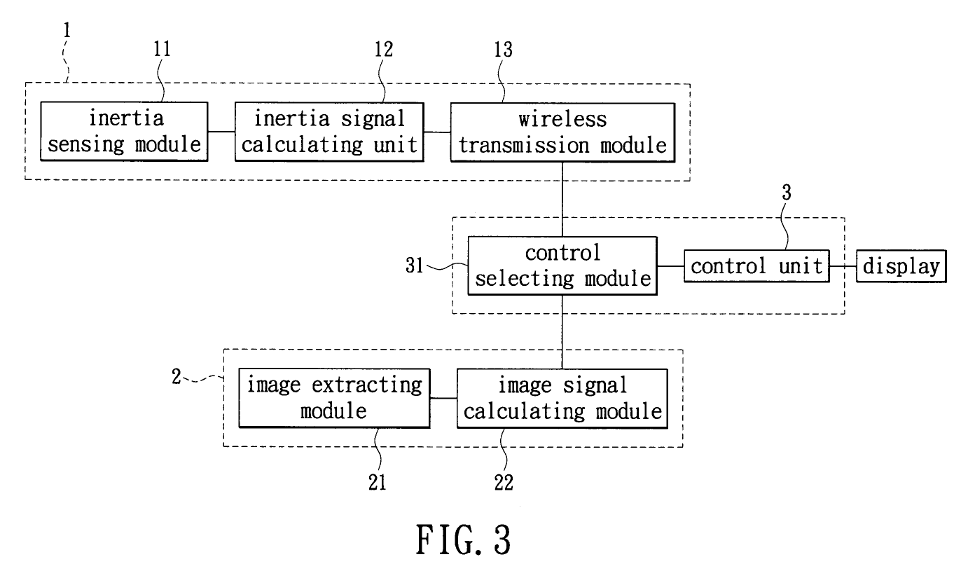

Please refer to FIG. 3, which shows a further embodiment of the present invention. The control unit 3 comprises a control selecting module 31. By inputting control instructions by the user or via electronic game software, the control selecting module 31 can generate signals to the control unit 3, thereby causing the control unit 3 to receive all or part of the signals from the inertia sensing and wireless transmission unit 1 and the image sensing unit 2. As a result, the control unit 3 has three different modes of receiving signals as follows. (I) Only the signals of one inputting unit are used, that is, either the signals of the inertia sensing and wireless transmission unit 1 or the signals of the image sensing unit 2 are used. (II) Only signals of the inputting unit that first indicates motion in any particular game will be used in that game. (III) The signals of the two units are used simultaneously. The user can convert the modes of sensing and inputting signals according to the contents of the electronic game or his/her habit of playing the game.

According to the embodiments of the present invention, the inertia sensing and wireless transmission unit 1 is used to sense the acceleration and angular speed of the user's body to generate signals indicative of the rotation, rhythmic motions, swing or force of the user's body. Thus, the present invention has high sensitivity and conforms to the requirement for prompt control. The image sensing unit 2 extracts the images of the profile of the user's body and processes the images to generate signals indicative of the displacement or special posture of the user's body. Thus, with looking at the display picture of the electronic game, the user can observe his/her motions and thus make response promptly according to the contents of the game, thereby increasing the correlation with the contents of the game in playing the interactive electronic game. With the control unit 3 integrating the signals from the inertia sensing and wireless transmission unit 1 and the image sensing unit 2, the present invention has high sensitivity and conforms to the requirement for prompt control. As a result, the procedure or device for processing images can be simplified. Further, with the cooperation between the inertia sensing and wireless transmission unit 1 and the image sensing unit 2, the present invention can act as a more complete and exquisite control interface for an electronic game, thereby increasing the fun in playing the interactive and simulated electronic games.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic game controller with motion-sensing capability for sensing profile and motions of a user to generate signals, thereby controlling a marker on a display picture of an electronic game, the electronic game controller comprising:
an inertia sensing and wireless transmission unit comprising an inertia sensing module, an inertia signal calculating module and a wireless transmission module, the inertia sensing module sensing the acceleration and angular speed of the motion of the user to generate signals, the inertia signal calculating module receiving the signals from the inertia sensing module to generate new signals indicative of the acceleration and angular speed of the motion of the user, the wireless transmission module receiving the signals from the inertia signal calculating module and outputting the signals by means of wireless transmission;
an image sensing unit comprising an image extracting module and an image signal calculating module, the image extracting module receiving all or part of the images of the profile of the user's body, the image signal calculating module receiving the images extracted by the image extracting module and digitizing the images, thereby recognizing the change of the images in a time axis and outputting the signals indicative of the displacement of the user's body; and
a control unit receiving and integrating the signals from the wireless transmission module and the image signal calculating module to generate control signals, thereby controlling the marker on the display picture of the electronic game.

2. The electronic game controller with motion-sensing capability according to claim 1, further comprising an operating device, the inertia sensing and wireless transmission unit being mounted in the operating device.

3. The electronic game controller with motion-sensing capability according to claim 1, wherein the inertia sensing module comprises at least one accelerometer and at least one gyroscope.

4. The electronic game controller with motion-sensing capability according to claim 1, wherein the image extracting module comprises one or plural video cameras.

5. The electronic game controller with motion-sensing capability according to claim 1, wherein the control unit further comprises a control selecting module, the control selecting module receiving instructions from the user or the electronic game to generate signals to the control unit, and according to the signals from the control selecting module the control unit receives all of or part of the signals sent by the inertia sensing and wireless transmission unit and the image sensing unit.
